(19) United States
(12) Patent Application Publication
(10) Pub. No.: US 2012/0288589 A1
(43) Pub. Date: Nov. 15, 2012

(54) METHOD AND APPARATUS FOR VITAMIN D ENHANCEMENT IN DRIED MUSHROOM POWDER

(75) Inventors: William F. Chalupa, Landenberg, PA (US); Gary M. Schroeder, Landenberg, PA (US)

(73) Assignee: Oakshire Holdings, Inc., Kennett Square, PA (US)

(21) Appl. No.: 13/469,168

(22) Filed: May 11, 2012

Related U.S. Application Data
(60) Provisional application No. 61/486,222, filed on May 13, 2011.
(60) Provisional application No. 61/498,371, filed on Jun. 17, 2011.

(51) Int. Cl. A23L 1/28; A23N 15/00; A23L 1/303

(52) U.S. Cl. 426/73; 426/248; 99/451

(57) ABSTRACT

An apparatus and method for increasing Vitamin D content in dried mushroom powder irradiates the powder with one or more pulses of UV light with wavelengths in the range of about 200 to about 800 nanometers. The powder may be conveyed into the light chamber with a vibratory conveyor. The irradiated mushroom powder has a Vitamin D2 level of at least 14,000 IU/gram.

### CROSS-REFERENCE TO RELATED APPLICATIONS

This application claims priority from U.S. provisional application Ser. Nos. 61/486,222, filed on May 13, 2011, and 61/498,371, filed Jun. 17, 2011.

### BACKGROUND OF THE INVENTION

1. Field of the Invention

This invention relates to a method and apparatus for increasing Vitamin D content in dried mushroom powder by exposing the powder to a broad spectrum of light for a specified period of time, using an electric glow discharge lamp. A mushroom powder having high levels of Vitamin D2 is produced that is all natural, vegetarian, and can be used as an ingredient to fortify foods at extremely low usage levels.

2. Description of the Prior Art

The two major forms of Vitamin D are Vitamin D2 and D3. Vitamin D2 is not produced by the human body and is only derived from fungi and plant sources. Vitamin D3 is produced in human skin through exposure to sunlight. The benefits of Vitamin D are numerous, and deficiency in the vitamin in humans can lead to several diseases. Because human exposure to sunlight for prolonged periods is impractical, in order to receive the benefits and overcome potential deficiencies in Vitamin D, there is a need for a method and an apparatus to increase Vitamin D2 in mushrooms and in dried mushroom powder to create a foodsource for this important vitamin.

Commercially grown mushrooms contain very low mass fractions of Vitamin D2, typically less than 20 International Units (IU) per 85 gram standard fresh serving. By “mass fraction,” we mean the IUPAC definition, i.e., Mass of a constituent divided by the total mass of all constituents in the mixture. In this case, “mass fraction” means the mass of Vitamin D2 divided by total mass of the mushrooms and their components. 40 IU of Vitamin D2 equals 1 microgram.

Mushrooms, however, naturally contain ergosterol, a biological precursor to Vitamin D2. Research shows that ergosterol in several species of mushrooms converts to Vitamin D2 when exposed to UV light. White button mushrooms, brown portobello mushrooms, shiitake mushrooms, and oyster mushrooms are some types of mushrooms known to show a Vitamin D2 response when exposed to UV light. With sufficient duration and exposure, the mass fraction of Vitamin D2 in these and other mushroom species can reach or exceed 400 IU/85 g of fresh mushrooms, equating to 100% of the current recommended Daily Value for Vitamin D in the United States.

To increase Vitamin D level in mushrooms, there are some reports of exposing mushrooms to UV light for extended periods to achieve an increase in the level of Vitamin D. In one example, exposure times from 1 hour to 24 hours were required. In other examples, 20 minutes to 60 minutes of exposure time were required. See Jasinghe, V. J., Perera, C. O., “Distribution of ergosterol in different tissues of mushrooms and its effect on the conversion of ergosterol to vitamin D2 by UV irradiation,” Food Chem. (2005), 92, pp. 541-46; Jasinghe, V. J., Perera, C. O., “UV irradiation: The generator of Vitamin D2 in edible mushrooms,” Food Chem. (2006), 95, pp. 638-43; and Jasinghe, V. J. “Conversion of ergosterol in edible mushrooms to Vitamin D2 by UV radiation,” Thesis submitted to the Department of Chemistry, National University of Singapore (2005).

Kawazoe and Yuasa in Japanese Patent Application No. H02-310180, filed Nov. 17, 1990 (Kawazoe 1990) and in “Producing Vitamin D2-Fortified Shiitake Mushroom Powder in Ultraviolet Irradiation Device”, Nippon Shokuhin Kagaku Kogaku Kaishi, Vol 44, No 6, 442-446 (1997) (Kawazoe 1997) give an example of increasing the Vitamin D2 content of mushroom powder by irradiating mushroom powder with ultraviolet rays under micro-vibration conditions. A device is described for simultaneous irradiation and agitation of mushroom powder. However, the ultraviolet ray generator is a low intensity 19W germicidal lamp (Kawazoe 1990) or three SGL-1000 lamps manufactured by Nippon Electric (Kawazoe 1997), the duration of continuous irradiation is quite long (40 sec-30 min), and the mushroom powder particle size is large (1-2 mm) A maximum mass fraction of Vitamin D2 of 326 micrograms/g of powder (about 13,040 IU/g) is produced.

FIGS. 2 and 3 of Kawazoe 1997 show that using the method of Kawazoe and Yuasa, irradiation for a longer period of time or with more intense light actually reduces the mass fraction of Vitamin D2 in the mushroom powder. These charts show that the maximum mass fraction of Vitamin D2 which can be produced using the method and apparatus of Kawazoe and Yuasa is about 326 micrograms/g of powder (about 13,040 IU/g). Kawazoe 1997 states that “[f]or a feed rate of 3.3 kg/h, the shiitake mushroom vitamin D₂ content increased in proportion to irradiation time, with a level of 326 μg/g at an irradiation time of 120 sec. However, the shiitake mushroom vitamin D₂ level decreased when the irradiation time was additionally increased,” and “[t]his phenomenon is thought to be due to decomposition of the generated vitamin D₂ as a result of excessive irradiation.”

The irradiation interval of Kawazoe 1990 and Kawazoe 1997 is long—40 sec to 30 min By “irradiation interval”, we mean the cumulated total time during which the mushroom powder is subjected to radiation. For example, if the time of irradiation is 5 continuous minutes, the irradiation interval is 5 minutes. If there are 18 pulses of 2 milliseconds each, the irradiation interval is 36 milliseconds.

Kawazoe 1997 also reports the result of increasing irradiation intensity at a relatively slow conveyor rate where the mushroom powder is fully irradiated: “At a feed rate of 3.3 kg/h, the shiitake mushroom vitamin D₂ level was approximately the same at ultraviolet light intensities of 7.2 and 10.1 mW/cm²” and “[d]ecomposition of the generated vitamin D₂ occurred and no increase in shiitake mushroom vitamin D₂ levels was found at higher ultraviolet light intensities.”

FIG. 5 of Kawazoe 1997 shows that in the method of Kawazoe and Yuasa, reducing the particle size of the mushroom powder has only a small effect on mass fraction of Vitamin D2 produced with changing the screen aperture size from 4 mm to 0.2 mm. The paper states “[t]he vitamin D₂ level increased along with decreasing mean particle diameter, but the rate of increase was small. In addition, no significant effects were seen as a result of specific surface area” and “[h]owever, the particle size had little influence with this device.” Kawazoe and Yuasa fail to understand or teach the importance of correct particle sizing combined with high intensity pulsed illumination in maximizing the yield and mass fraction of Vitamin D2 and in minimizing irradiation time.

We discovered a method to produce a much higher mass fraction of Vitamin D2 using a much shorter irradiation interval, and achieve mushroom powder with a much higher mass fraction of Vitamin D2. It would be advantageous to develop a method for treating commercially viable quantities of dried mushroom powder for short treatment times to produce dried mushroom powders with as high Vitamin D2 contents as possible.

### SUMMARY OF INVENTION

One embodiment of the present disclosure is a method for increasing vitamin D content of a mushroom powder. A mushroom powder having particles with particle sizes not larger than about 2 mm is irradiated with one or more pulses of ultraviolet light with wavelengths in the range of about 200 to about 800 nanometers emitted by an electric glow discharge lamp, such as a xenon lamp. Preferably, the mushroom powder is dried to a moisture content of less than about 30% moisture by weight before the powder is irradiated. Ideally, the mushroom powder is vibrated as it is irradiated. The resulting irradiated mushroom powder has a Vitamin D2 level of at least 14000 IU/gram, preferably at least 20000 IU/gram, and most preferably at least 24000 IU/gram. This irradiated mushroom powder may be used as a condiment to be sprinkled on or into foods, or may be incorporated into a consumable food product.

The mushroom powder may be made from one or more mushrooms of various types, including but not limited to, white button mushrooms, brown portobello mushrooms, shiitake mushrooms, maitake mushrooms, oyster mushrooms, and mixtures thereof. In one especially preferred embodiment, the powder is made from gills only of one or more types of mushrooms. The mass ratio of Vitamin D2 to ergosterol of the mushroom powder after irradiation can be at least 1/1 or greater.

Without intending to be limiting, one embodiment of an apparatus for increasing vitamin D content of a mushroom powder includes an electric glow discharge lamp capable of emitting pulses of light with wavelengths in the range of about 200 to about 800 nanometers, such as a xenon lamp, and a conveyor to convey the mushroom powder for exposure to one or more pulses of light by the lamp. Preferably, the electric glow discharge lamp is enclosed in a light chamber that is provided with means for controlling temperature therein, such as a blower and exhaust. In one embodiment, the xenon lamp pulses 3 times per second for about 2 milliseconds per pulse. Preferably, the conveyor is a type that shakes or vibrates the mushroom powder as it is conveyed for exposure to radiation. Examples are vibrating conveyors, shaker tables, vibrating pans and vibrating chutes. Preferably, the conveyor vibrates at a frequency in the range of 1 Hz to 50 Hz.

In one embodiment, the vibration frequency is adjusted so that the mushroom powder travels through the illumination in about 6 seconds. In this embodiment, the tray across which the mushroom powder traverses is about 4.5 inches by 7 inches. Since the illumination in this embodiment pulses 3 times per second, the powder is exposed to 18 pulses in the 6 second time. If it is desired to expose the powder to more than 18 pulses, in another embodiment, the powder can be collected and passed two or more times through the illumination chamber. Alternatively, there can be two or more illumination chambers in series through which the powder passes.

### BRIEF DESCRIPTION OF THE DRAWINGS

FIG. 1 is a schematic front elevational view of an apparatus for treating dried mushroom powder with UV radiation; and

FIG. 2 is a representative plot of relative irradiance versus wavelength of light that is generated by a xenon pulsed UV light emitting electric glow discharge lamp.

### DETAILED DESCRIPTION OF THE PREFERRED EMBODIMENTS

As a first step, fresh mushrooms are cultivated using traditional methods. After harvesting, any part of the mushroom can be used including stems, caps, stumps, waste material from the slicing process, or culls otherwise unfit for sale to the fresh market. The growing medium used to produce the mushrooms can also be considered a raw material source for production of animal feed type products. The seed or source material used to grow mushrooms commonly referred to as spawn can also be used.

Next, the whole mushrooms or mushroom pieces are dried to produce a shelf stable low moisture product having a moisture content of less than about 30% moisture by weight. This shelf stable low moisture product (mushroom pieces) typically would have about 8-15% moisture by weight. The mushrooms and mushroom pieces may be dried in a number of ways, including but not limited to a batch type process using air convection, or a fluid bed type dryer, as well as a combination type apparatus that performs drying and grinding simultaneously.

The dried mushrooms and mushroom pieces then are ground into a powder using standard grinding methods to produce a powder with a particle size specific to its intended application. For example if the intended application is to use the powder at low usage levels to fortify a processed food with Vitamin D, a small particle may be desired. If the intended application of the powder is for use as a condiment or seasoning, a larger particle might be preferred.

The mushroom powder particles preferably will pass through a 10 mesh screen (about 2 mm), more preferably pass through a 20 mesh screen (about 850 microns), and still more preferably will pass through a 30 mesh screen (about 600 microns) and still more preferably will pass through a 70 mesh screen (about 210 microns), and most preferably will pass through a 170 mesh screen (about 90 microns).

The mushroom powder is then conveyed under a xenon pulsed light on an oscillating or vibratory conveyor which agitates the powder in order to ensure that, to the maximum extent practical, each particle of the powder receives an effective quantity of pulsed UV light. This agitation of powder in connection with exposure to UV results in a very high conversion of ergosterol naturally present in the mushroom tissue to Vitamin D2. The continuous process allows for the commercial production of mushroom powder with dramatically enhanced levels of vitamin D2. After irradiation, the Vitamin D2 mass fraction in the dried mushroom powder is preferably at least 14000 IU/g, more preferably at least 20,000 IU/g, still more preferably at least 24,000 IU/gram. Unexpectedly, we achieved Vitamin D2 levels of at least 14,000 IU/gram. These levels of Vitamin D2 in mushrooms had not been previously reported, and were thought not possible.

We have found that particle size can impact the level of Vitamin D that can be achieved in the mushroom powder. Without intending to be limiting as to mechanism, we believe that whatever the UV light source used, the UV exposure will only convert ergosterol to vitamin D2 to a relatively narrow optical depth, namely, without intending to be limiting, to a penetration depth of 45 microns or less.

Many different mushroom species can be used in this process. Our results suggest that all mushroom species we have evaluated can be used, specifically including, but not limited to, white button, agaricus bisporus, shiitake, oyster, and maitake.

Different parts of the mushroom contain different concentrations of ergosterol. By excising and drying only certain portions of the mushroom, such as the gills, a powder can be obtained which is higher in ergosterol than the average made from powder made from whole mushrooms. Powder higher in starting ergosterol produces a higher level of vitamin D2 upon irradiation.

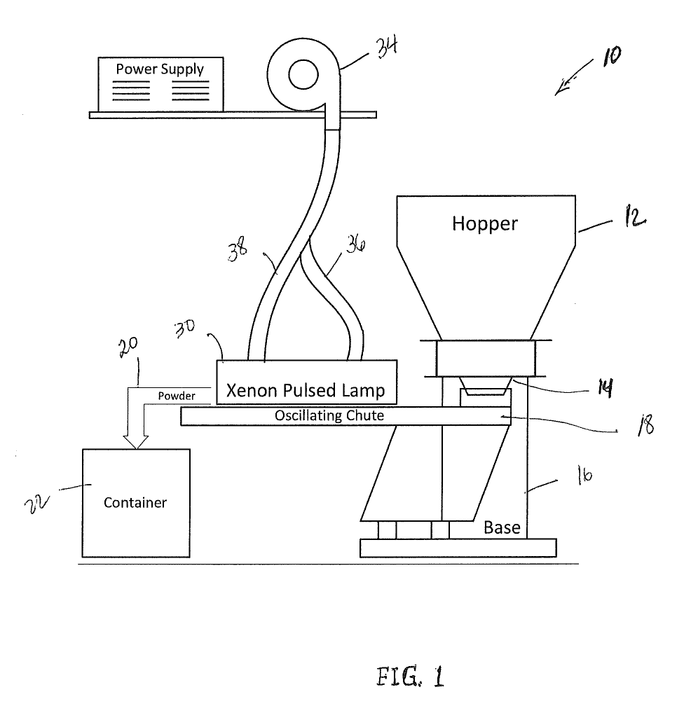

Referring first to FIG. 1, an apparatus 10 for increasing Vitamin D content in mushroom powder is shown schematically. The mushroom powder is introduced into a hopper 12 that is mounted on a base 16. The hopper 12 terminates in a funnel or exit portion that drops the mushroom powder 20 onto a vibratory conveyor or oscillating chute 18. The conveyor conveys the mushroom powder 20 into a light chamber 30 that houses an electric glow discharge lamp, such as a xenon pulsed lamp (not shown in FIG. 1). In one embodiment, the tray across which the mushroom powder traverses is about 4.5 inches by 7 inches.

To control temperature within the light chamber 30, air is blown into the light chamber 30 using a blower 34. Connected to the blower 34 is an intake hose 36 used to force air into the light chamber 36. The forced air is then removed from the light chamber 30 using an outlet hose 38. We found that it is beneficial, and in some embodiments, necessary, to use the blower because the lamp can generate so much heat that, without the forced air ventilation and cooling, components of the lamp and illumination assembly can melt or otherwise become inoperative. The forced air ventilation also helps control the temperature of the mushroom powder so that it does not burn or cook.

The conveyor conveys the mushroom powder through the light chamber 30 while the lamp directs UV light radiation onto the mushroom powder. The conveyor oscillates or vibrates or shakes to distribute the mushroom powder onto the conveyor, and to direct the radiation onto a significant portion of the surface area of the powder. In this embodiment, the conveyor vibrates at a rate between 1 Hz and 50 Hz, and is adjusted so that the powder passes through the illumination chamber in 6 seconds. Since the lamp pulses 3 times per second, the powder receives 18 pulses while traversing through the illumination chamber. If it is desired to expose the powder to more than 18 pulses, the powder can be collected and passed two or more times through the illumination chamber. Alternatively, two or more illumination chambers can be used so the powder passes, in series, through the two or more illumination chambers.

The irradiated mushroom powder 20 is then deposited into a container 22 as desired.

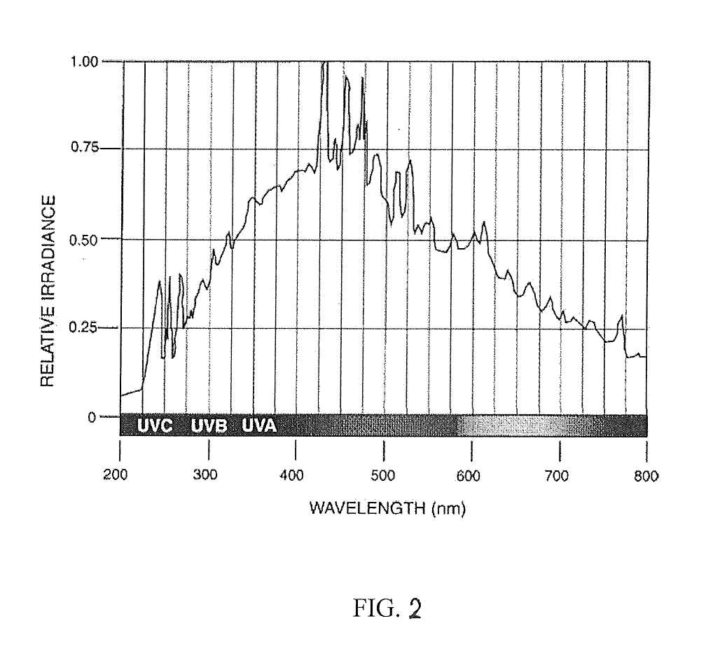

A more intense UV light-emitting source was found to increase processing speed. Intense bursts of light can be emitted from pulsed lamps made with xenon gas. These pulses of light from xenon lamps occur in less than 2 milliseconds and create a broad spectrum of UV light. One type of xenon pulse lamp that has been used is Model RC-747-16 manufactured by Xenon Corporation. This xenon pulse lamp, delivers at least 505 joules total light energy per pulse. FIG. 2 illustrates the spectrum for the Model RC-747-16 xenon pulse lamp. This type of high intensity lamp emits pulses of UV radiation with an intensity of at least 1.26 J/cm² at 1″ from the window face of the lamp.

Preferably, the UV radiation emitted by the UV light-emitting source has wavelengths in the range of about 200 to about 800 nanometers. Without intending to be limiting as to mechanism, we believe that it is UV-B radiation which is most effective in the photoisomerization of ergesterol to Vitamin D2.

The FDA has ruled on the safety of food exposed to xenon lamp pulsed light exposure.

Food and Drug Administration Issues Approval for Pulsed UV Light in the Production, Processing and Handling of Food

Code 21CFR179.41, issued by the Food and Drug Administration (FDA), Department of Health and Human Services, approves the use of Pulsed UV light in the production, processing and handling of food.

Title 21—FOOD AND DRUGS (Page 438)

Chapter I—FOOD AND DRUG ADMINISTRATION, DEPARTMENT OF HEALTH AND HUMAN SERVICES Part 179—IRRADIATION IN THE PRODUCTION, PROCESSING AND HANDLING OF FOOD

Subpart B—Radiation and Radiation Sources

Sec. 179.41 Pulsed light for the treatment of food

Pulsed light may be safely used for the treatment of foods under the following conditions:

(a) The radiation sources consist of xenon flashlamps designed to emit broadband radiation consisting of wavelengths covering the range of 200 to 1,000 nanometers (nm), and operated so that the pulse duration is no longer than 2 milliseconds (ms);

(b) The treatment is used for surface microorganism control;

(c) Foods treated with pulsed light shall receive the minimum treatment reasonably required to accomplish the intended technical effect; and

(d) The total cumulative treatment shall not exceed 12.0 joules/square centimeter (J/cm²).

The FDA guideline uses pulsed light for surface microorganism control. Mushrooms that are exposed to xenon lamp radiation for 2 milliseconds are within the FDA guideline for food safety. Surprisingly, this short duration exposure can be sufficient to achieve significant enhancement of Vitamin D in mushrooms.

If the mushroom powder was agitated as the powder traverses the UV light exposure area so as to expose most or all of the individual particles to UV light, significantly higher levels of vitamin D were achieved than with powder particles that were not agitated. The resulting powder has such a high level of vitamin D that it could now economically be used as an all natural, vegetarian source of vitamin D2 in processed food products at very low usage levels without dramatically affecting the flavor, appearance, or cost of the finished product.

A vibratory conveyor is able to take bulk quantities of mushroom powder and create an extremely thin layer of particles. The thin layer ensures each individual particle receives sufficient exposure to pulsed UV light to maximize conversion of ergosterol to vitamin D2. The combination of vibrating conveyor creating a very thin layer of particles in combination with pulsed UV light allows for the rapid and efficient conversion to vitamin D at very high levels in a commercial environment. Ideally, there will be a single layer of powder as the powder traverses on the conveyor.

In summary, the combination of powder particle size, pulsed UV light, and vibrating conveyor allows to inventors to continuously produce mushroom powder with extremely high levels of vitamin D2 on a commercial scale economically.

### EXAMPLES

### Example 1

Whole mushrooms of the species agaricus bisporus are dried to about 10% moisture using a convection dryer. In one embodiment of drying, about 100 g of mushroom powder are placed in an oven at about 150° F. for 36 hours. The mass fraction of moisture remaining in the powder is about 8-12%. The dried mushrooms are then ground to powder using a hammer mill. The resulting powder is passed through a 30 mesh screen, and particles which do not pass through the screen are removed. The particles that pass through the screen are conveyed by vibratory conveyor to the UV exposure device. The vibratory conveyor is operated continuously during irradiation of the dried mushroom particles. The particles are continuously fed onto the conveyor so that the depth of solid particles is maintained at about ⅛ inch. The particles are irradiated using a Model RC-747-16 xenon pulsed lamp manufactured by Xenon Corporation. The pulse is about 2 milliseconds in duration. The particles are exposed to 108 pulses in the UV exposure device. The distance from the UV lamp to the closest point of the vibrating conveyor is about 4 inches. A blower is used to regulate the temperature of the particles during UV exposure. The temperature is kept sufficiently low such that no component of the lamp melts or is rendered inoperative. The powder is collected after passing through the irradiation apparatus. After exposure, the Vitamin D2 is measured and determined to be at least 7500 IU/g of mushroom powder. (187.5 micrograms/g of mushroom powder). The Vitamin D2 content is measured by standard commercial methods using HPLC and/or LC/MS/MS.

### Example 2

Mushroom powder is produced in a manner similar to Example 1 except that all powder is passed through a 70 mesh screen. Irradiation and collection are carried out in a manner similar to Example 1. Mass fraction of Vitamin D2 in the powder of Example 2 is determined to be higher after irradiation than in the powder of Example 1.

### Example 3

Mushroom powder is produced in the same manner as Example 1. It is irradiated and shaken or vibrated as outlined in Table 1 below. The resulting Vitamin D2 content is measured and reported.

TABLE 1

| | | | Maximum | mg | |
|---|---|---|---|---|---|
| Treat- | # | Vitamin | Particle | Powder | |
| ment | light | D2 | Size | per | |
| # | pulses | IU/gram | (microns) | sq cm | Comments |
| 1 | 0 | 12 | 850 | | Control, no UV |
| | | | | | exposure |
| 2 | 36 | 2680 | 850 | 43.6 | 15 gr; 18 pulses; |
| | | | | | powder shaken to |
| | | | | | redistribute particles |
| | | | | | and then 18 more |
| | | | | | pulses |
| 3 | 72 | 5180 | 850 | 43.6 | 15 gr; 18 pulses; |
| | | | | | powder shaken to |
| | | | | | redistribute particles |
| | | | | | and then 18 more |
| | | | | | pulses |
| 4 | 108 | 7840 | 850 | 43.6 | 15 gr; 18 pulses; |
| | | | | | powder shaken to |
| | | | | | redistribute particles |
| | | | | | and then 18 more |
| | | | | | pulses |
| 5 | 18 | 14703 | 500 | 21.8 | 7.5 gr; 18 pulses |
| 6 | 36 | 24424 | 212 | 1.4 | 1 gr; 18 pulses; |
| | | | | | powder shaken to |
| | | | | | redistribute particles |
| | | | | | and then 18 more |
| | | | | | pulses |
| 7 | 36 | 32014 | 90 | 0.8 | 1 gr; 18 pulses; |
| | | | | | powder shaken to |
| | | | | | redistribute particles |
| | | | | | and then 18 more |
| | | | | | pulses |

### Example 4

Mushroom powder is prepared as for Example 1 except that the particles are passed through a 70 mesh screen which passes particles smaller than 212 microns. The particles are continuously fed onto the conveyor so that the depth of solid particles is as close to a monolayer of particles as possible. The particles are irradiated using a Model RC-747-16 manufactured by Xenon Corporation. The pulse is about 2 milliseconds in duration. The particles are exposed to 18 pulses, agitated, repositioned on the conveyor and exposed to another 18 pulses. Distance from the UV lamp to the closest point of the vibrating conveyor is about 2 inches. The powder is collected after passing through the irradiation apparatus. A blower is used to regulate the temperature of the illumination chamber and mushroom particles during UV exposure. After exposure, the Vitamin D2 is measured and determined to be 24,400 IU/g of mushroom powder (611 micrograms/g of mushroom powder).

### Example 5

Mushroom powder is prepared and irradiated as in Example 4 except that the powder before irradiation is passed through a 170 mesh screen which passes particles of maximum size about 90 microns. After exposure, the Vitamin D2 is measured and the mass fraction is determined to be 32,000 IU/g of mushroom powder (800 micrograms/g of mushroom powder).

### Example 6

Mushroom powder is prepared and irradiated as in Example 4 except that the powder before irradiation is passed through a 170 mesh screen which passes particles of maximum size about 90 microns. After exposure, theVitamin D2 is measured and the mass fraction is determined to be 29,800IU/g of mushroom powder (747 micrograms/g of mushroom powder).

### Example 7

Mushroom powder is prepared and irradiated as in Example 4. This powder is blended with unirradiated powder in a weight ratio of 1 part irradiated powder to 10 parts unirradiated powder. The result is Vitamin D2 mass fraction in the resulting powder of about 2400 IU/g.

### Example 8

A blend of mushroom powder is prepared as in Example 7 except that the weight ratio is 1 part irradiated powder to 60 parts unirradiated powder. The result is Vitamin D2 mass fraction in the resulting powder of about 400 IU/g.

### Example 9

The powder of Example 7 is blended with the unirradiated powder in a weight ratio of 1 part of the powder of Example 7 to 6 parts unirradiated powder. The result is Vitamin D2 mass fraction in the resulting powder of about 400 IU/g.

### Example 10

The powder of Example 5 is analyzed for ergosterol subsequent to irradiation. The ratio of Vitamin D2 to ergosterol subsequent to irradiation is calculated. The ratio of Vitamin D2 to ergosterol by weight is at least 1/1 or greater.

The disclosure has been illustrated by detailed description and examples of particular embodiments. Various changes in form and detail may be made to the illustrative embodiments without departing from the spirit and scope of the present invention. Therefore, the invention must be measured by the claims and not by the description of the examples or the particular embodiments.

1. A method for increasing vitamin D content of a dried mushroom powder, comprising:
providing a dried mushroom powder having particles with particle sizes not larger than about 2 mm; and
irradiating the mushroom powder with one or more pulses of ultraviolet light with wavelengths in the range of about 200 to about 800 nanometers emitted by an electric glow discharge lamp.

2. The method of claim 1, wherein the electric glow discharge lamp is a xenon lamp.

3. The method of claim 2 wherein irradiating is carried out for an illumination interval of 1 second or less.

4. The method of claim 2, wherein the xenon lamp emits pulses, and no pulse is longer than 3 milliseconds.

5. The method of claim 1, wherein the irradiated mushroom powder has a mass fraction of Vitamin D2 of at least 14,000 IU/gram of powder.

6. The method of claim 5, wherein the irradiated mushroom powder is sized such that it will pass through a 30 mesh screen.

7. The method of claim 1, wherein the irradiated mushroom powder has a mass fraction of Vitamin D2 of at least 20,000 IU/gram of powder.

8. The method of claim 1, wherein the irradiated mushroom powder has a mass fraction of Vitamin D2 of at least 24,000 IU/gram of powder.

9. The method of claim 8, wherein the irradiated mushroom powder is sized such that it will pass through a 70 mesh screen.

10. The method of claim 8, wherein the irradiated mushroom powder has a mass fraction of Vitamin D2 of at least 30,000 IU/gram of powder.

11. The method of claim 10, wherein the irradiated mushroom powder is sized such that it will pass through a 170 mesh screen.

12. An apparatus for increasing vitamin D content of a mushroom powder, comprising:
a light chamber housing a xenon electric glow discharge lamp, said lamp capable of emitting pulses of light with wavelengths in the range of about 200 to about 800 nanometers;
a conveyor to convey a mushroom powder having particles with particle sizes not larger than about 2 mm for exposure to one or more pulses of light by the lamp, wherein the conveyor is selected from the group consisting of: vibrating conveyor, shaker table, vibrating pan and vibrating chute; and
means for controlling temperature within the light chamber.

13. A mushroom powder, comprising:
dried whole mushrooms or mushroom pieces ground to a powder with particle sizes not exceeding about 2 mm, said mushroom powder having a mass fraction of Vitamin D2 of at least 14000 IU/gram of powder.

14. The mushroom powder of claim 13, wherein the powder is made from one or more mushrooms selected from the group consisting of: white button mushrooms, brown portobello mushrooms, shiitake mushrooms, oyster mushrooms, and mixtures thereof.

15. The mushroom powder of claim 13, wherein the mushroom powder has a mass fraction of Vitamin D2 of at least 20,000 IU/gram of powder.

16. The mushroom powder of claim 13, wherein the mushroom powder has a mass fraction of Vitamin D2 of at least 24,000 IU/gram of powder.

17. The mushroom powder of claim 13, wherein the mushroom powder has a mass fraction of Vitamin D2 of at least 30,000 IU/gram of powder.

18. The mushroom powder of claim 13, wherein the dried mushroom pieces comprise gills only of one or more types of mushrooms.

19. The mushroom powder of claim 18, wherein the ratio of Vitamin D2 to ergosterol comprises at least 1/1 or greater.

20. A consumable food product comprising: the mushroom powder of claim 13.

21. A mushroom powder comprising: a blend of the irradiated mushroom powder of claim 13, and mushroom powder that has not been irradiated.
